(19) United States
(12) Patent Application Publication
(10) Pub. No.: US 2026/0356298 A1
(43) Pub. Date: Nov. 12, 2026

(54) TAILGATE PROTECTION PAD SYSTEMS

(71) Applicant: Jeremiah J. Starkey, Durango, CO (US)

(72) Inventor: Jeremiah J. Starkey, Durango, CO (US)

(21) Appl. No.: 19/204,057

(22) Filed: May 9, 2025

(51) Int. Cl. B60R 9/10; B60J 11/06

(52) U.S. Cl. CPC B60R 9/10; B60J 11/06

(57) ABSTRACT

A truck tailgate protector system includes a tailgate protection pad, an anchor, and a strap connecting the anchor to the tailgate protection pad. The anchor may be configured to insert through a gap between a truck tailgate and a truck bed when the tailgate is down. The anchor may also be configured to compress between the truck tailgate and truck bed when the tailgate is up. The tailgate protection pad also includes a cradle with an upper section that mates with a bicycle and a lower section shaped to mate with the upper inside edge of the truck's tailgate.

### FIELD OF THE INVENTION

The present invention relates generally to systems for protecting truck tailgates. Particularly, tailgate protection systems having a cradle to assist in securing a bicycle to a tailgate pad at an adequate standoff from the tailgate.

### BACKGROUND ART

Tailgate protection pads are often used to protect a truck tailgate from damage. For example, a tailgate protection pad may be used to protect the tailgate from a bicycle that may be placed over the tailgate in the upright position with the front wheel placed over the tailgate such that the frame and rear wheel of the bicycle sits in the bed of the truck and the rear wheel of the bicycle protrudes rear-ward from the truck bed.

Known tailgate protection systems are not entirely satisfactory for the range of applications in which they are employed. For example, existing tailgate protection systems either lack straps entirely or require that the user thread the straps through the tailgate hinge, between the tailgate and the truck, thereby making a complete loop around the tailgate. The conventional complete-loop style tailgate protectors provide secure attachment but are difficult and inefficient to remove or install. The conventional strap-free tailgate protectors are easy to install and remove, but are prone to becoming dislodge, especially in high winds or absent one or more bicycles to hold them down.

Further, known tailgate protection systems often lack sufficient structure to adequately secure a bicycle to the tailgate pad while protecting the tailgate. For example, existing tailgate protection systems either lack bicycle frame protection entirely or simply use a flat or raised piece of foam. The simple foam pieces do not provide an adequate standoff space to protect the cargo from the inside corner of the truck tailgate thereby allowing excessive movement and cargo damage. Additionally, the foam pieces are also positioned on the tailgate pad in a location that does not contribute to securing the tailgate pad to the tailgate.

Thus, there exists a need for tailgate protection pads that improve upon and advance the design of known protection pads. There further exists a need for a tailgate protection system with a tailgate pad having a cradle that contributes to securing the tailgate pad to the tailgate while securing the bicycle to the tailgate pad in a position that provides adequate standoff space between the bicycle and the tailgate to broaden protection of the truck tailgate.

### SUMMARY OF THE INVENTION

The present disclosure is directed to tailgate protection pad systems. In one embodiment, a truck tailgate protector system includes a tailgate protection pad, an anchor, and a strap connecting the anchor to the tailgate protection pad. The anchor may be configured to insert through a gap between a truck tailgate and a truck bed when the tailgate is down. The anchor may also be configured to compress between the truck tailgate and truck bed when the tailgate is up.

In one embodiment, a truck tailgate protector system includes a tailgate protection pad, a chock anchor, and a strap connecting the anchor to the tailgate protection pad. The chock anchor may be configured to insert through a gap between a truck tailgate and a truck bed when the tailgate is down. The chock anchor may also be configured to lodge beneath a short edge surface of tailgate when the tailgate is up.

In one embodiment, the system may include a tension adjuster disposed on the strap. In one embodiment, the tension adjuster may comprise plastic. In one embodiment, the strap may comprise nylon webbing.

In another embodiment, the tailgate protection pad comprises one or more magnets.

In one embodiment, the anchor is a first anchor and the strap is a first strap. The system may further comprise a second anchor, and a second strap connecting the second anchor to the tailgate protection pad. In another embodiment, the anchor comprises a high-density foam material.

In one embodiment, the tailgate protection pad includes a cradle attached to the protection pad. The cradle may be positioned on the pad and configured to mate with the truck tailgate. Additionally, the cradle assists in securing the bicycle to the pad. The cradle may be made of rigid or compressible material to prevent damage to the bicycle and tailgate.

In one embodiment, a system may include a truck tailgate pad, a cradle shaped to mate to a bicycle and an upper edge of a tailgate, and a strap attached to the cradle to secure the bicycle to the cradle. The cradle has an upper portion and a lower portion. The upper portion of the cradle is shaped to mate with a bicycle. The lower portion is shaped to mate with the inside corner of the truck tailgate. The cradle provides an adequate standoff space to protect the bicycle from the tailgate and assists in securing the tailgate pad to the tailgate to reduce movement of the tailgate pad and the bicycle when the tailgate pad is over the tailgate. In one embodiment, the cradle may be designed to not require a strap to secure the bicycle. The strap may be incorporated in the tailgate pad.

In one embodiment the shaped cradle may be made of plastic. In one embodiment the shaped cradle may be made of foam. In One embodiment it may be a combination of materials.

### BRIEF DESCRIPTION OF THE DRAWINGS

Embodiments of the present invention are illustrated by way of examples and are not limited to the accompanying drawings:

FIG. 1 is a side elevation view of a first example of a tailgate protection pad system, showing the tailgate down.

FIG. 2 is a side elevation view tailgate protection pad system shown in FIG. 1, showing the tailgate up.

FIG. 3 is a detail view of a first embodiment of an anchor in place between the tailgate and the bed of the truck, with the tailgate down.

FIG. 4 is a detail view of the anchor of FIG. 3, showing the anchor in place between the tailgate and the bed of the truck, with the tailgate up.

FIG. 5 is a detail view of a second embodiment of an anchor, a chock anchor, in place between the tailgate and the bed of the truck, with the tailgate down.

FIG. 6 is a detail view of the chock anchor of anchor of FIG. 5, showing the anchor in place between the tailgate and the bed of the truck, with the tailgate up.

FIG. 7 is a perspective view of the tailgate protection pad system, showing a plurality of straps anchored between the tailgate and the bed of the truck and a cradle mated to the top edge of the tailgate.

FIG. 8 is a perspective view of an embodiment of a cradle of the current invention.

### DETAILED DESCRIPTION OF INVENTION

The disclosed tailgate protection pad systems will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various tailgate protection pad systems are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

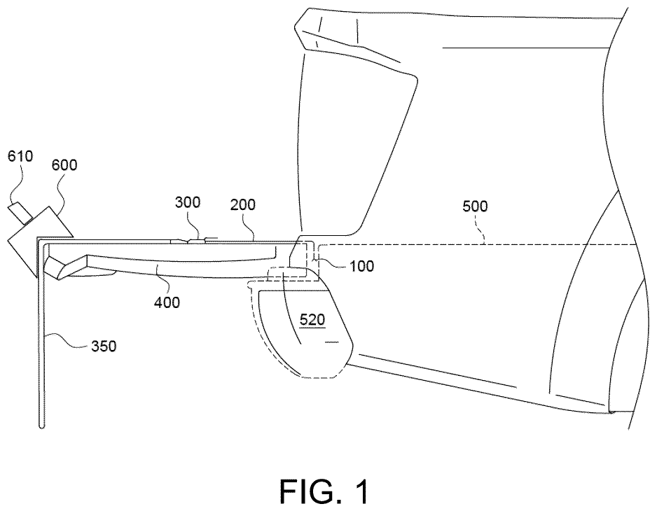

With reference to FIGS. 1-5, a first example of a tailgate protection pad system, system 10, will now be described. System 10 functions to protect the tailgate from dents and scratches, especially when one or more bicycles are placed over the tailgate. The reader will appreciate from the figures and description below that system 10 addresses shortcomings of conventional tailgate protectors.

For example, system 10 allows the user to quickly and easily secure the protection pad to the truck without the having to thread any straps all the way through the tailgate hinge. System 10 combines the ease of use of strap-free systems with the secure attachment of conventional strap systems.

System 10 includes a tailgate protection pad 350, an anchor 100, and a strap 200 connecting the anchor 100 to the tailgate protection pad 350. The anchor 100 may be configured to insert into a gap between a truck tailgate 400 and a truck bed 500 when the tailgate 400 is down. In some embodiments, the anchor 100 may be configured to compress between the truck tailgate 400 and truck bed 500 when the tailgate is up. In other embodiments, the anchor may be configured to lodge beneath a short edge surface of tailgate when the tailgate is up.

As can be seen in FIG. 1, system 10 may further include a strap tension adjustor 300 between the anchor 100 and the pad 350. With the tailgate 400 in a down position, as shown in FIG. 1, the anchor 100 may be placed by the user into a gap between the tailgate 400 and the truck bed 500. The truck may include bumper 520.

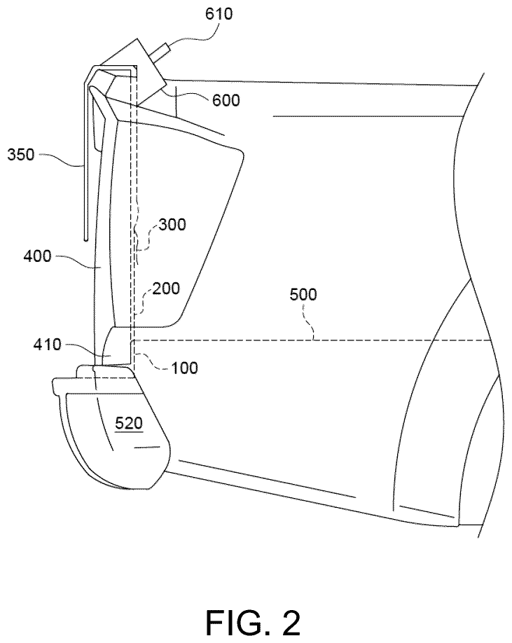

Turning now to FIG. 2, with the tailgate 400 in an up position, as shown, the anchor 100 may be compressed between the tailgate 400 and the truck bed 500. This compression of the anchor 100 may serve to secure the strap 200 to the truck. The user may then take any slack out of strap 200 via tension adjuster 300.

In some examples the protection pad may include one or more magnets. For example, one or more magnets may be disposed proximal the bottom edge of the protection pad, opposite the edge to which the straps are attached. These magnets may serve to keep the bottom edge of the protection pad from flapping in the wind when the protection pad is installed and the truck is moving.

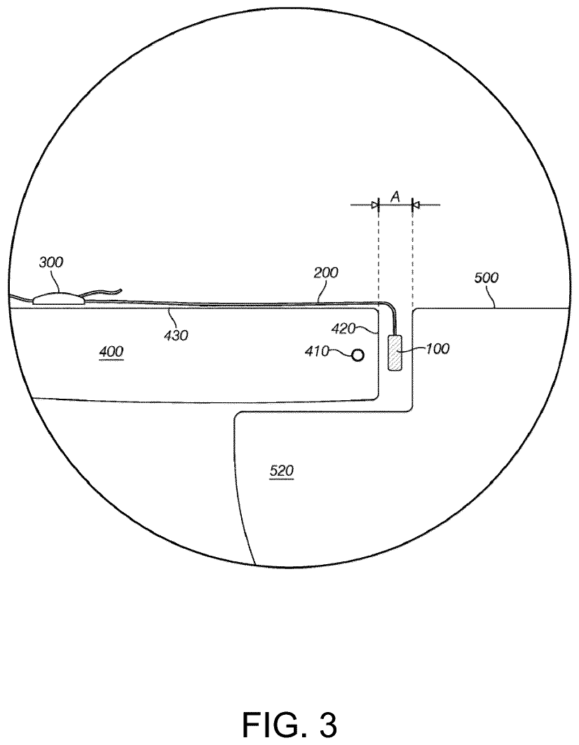

Turning now to FIG. 3, a detail view of the anchor 100 in place between the tailgate 400 and the bed of the truck 500 is shown, with the tailgate 400 in a down position. As can be seen, the gap between the bottom edge 420 of tailgate 400 and the truck bed 500 has width A. The anchor 100 may be configured to have a width of less than A, allowing a user to drape the pad 350 over the tailgate and easily slide the anchor 100 into the gap. The user may then put tailgate 400 to a n up position.

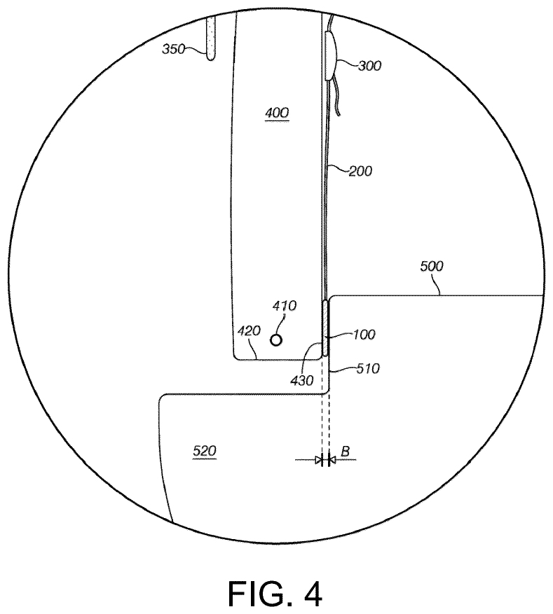

Turning to FIG. 4, once the tailgate has been put up, the anchor 100 is compressed between a side edge 430 of tailgate 400 and the edge 510 of the truck bed 500. As can been seen, due to the placement of tailgate pivot 410, the gap between the tailgate 400 and the truck bed 500 has width B. Width B may be significantly less than width A. Anchor 100 may be configured to have a uncompressed width greater than width B, such that when the tailgate 400 is raised to the up position, the anchor is compressed between a side edge 430 of tailgate 400 and the edge 510 of the truck bed 500. This compression may be so significant as to prevent the strap from being dislodged from the gap, so long and the tailgate remains in the up position.

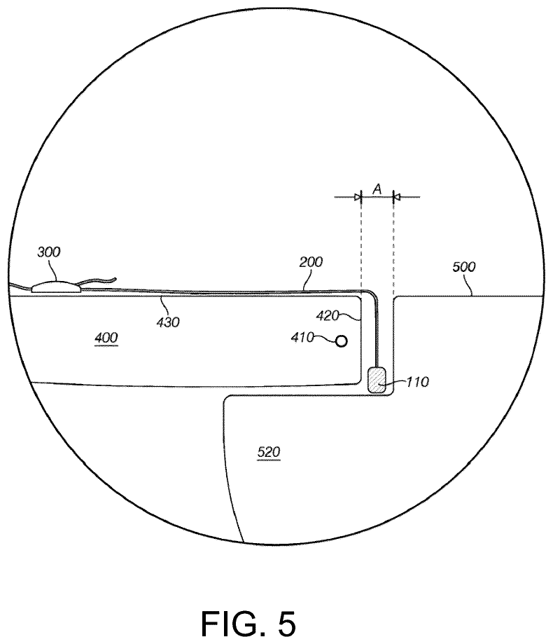

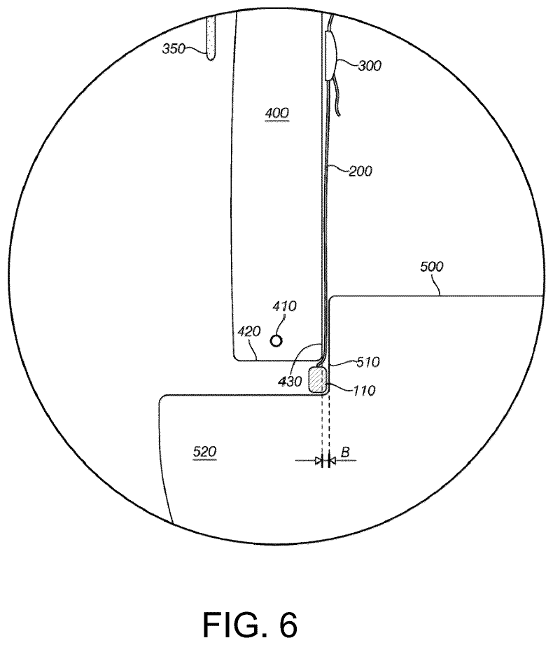

Turning now to FIGS. 5-6, a second embodiment of an anchor, chock anchor 110, is shown. As shown in FIG. 5, the anchor 110 may be placed between the tailgate 400 and the bed of the truck 500, with the tailgate 400 in a down position. As can be seen, the gap between the bottom edge 420 of tailgate 400 and the truck bed 500 has width A. The chock anchor 110 may be configured to have a width of less than A, allowing a user to drape the pad 350 over the tailgate and easily slide the chock anchor 110 into the gap. The user may then put tailgate 400 to an up position.

Turning to FIG. 6, once the tailgate has been put up, the chock anchor 110 is lodged beneath between a bottom edge 420 of tailgate 400 and the edge 510 of the truck bed 500. As can been seen, due to the placement of tailgate pivot 410, the gap between the tailgate 400 and the truck bed 500 has width B. Width B may be significantly less than width A. Chock anchor 110 may be configured to have a width greater than width B, such that when the tailgate 400 is raised to the up position, the chock anchor 110 is lodged beneath a bottom edge 420 of tailgate 400.

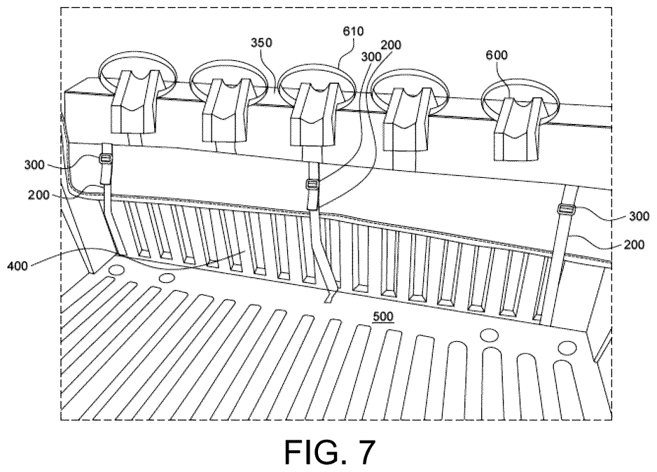

Turning now to FIG. 7, one embodiment of the system is shown. In the illustrated embodiment, the system includes three straps 200. In other embodiments, the system may include more or less straps.

In some embodiments, the tension adjuster 300 may be comprised of metal and/or plastic. In some embodiments, the strap 200 may be comprise of nylon webbing or other suitable material. In some embodiments, the pad may be comprised of a nylon cover with synthetic padding.

In an embodiment, FIG. 7 a tailgate protection system 10 includes a tailgate pad 350 and a cradle 600 attached to the tailgate pad 350. The cradle 600 is generally attached to an upper portion of the truck bed 500 side of the tailgate pad 350. The cradle 600 has an upper section 620 configured to mate to a portion of a bicycle and lower section 640 with configured to mate with an inside corner of a tailgate 400. When the tailgate pad 350 is over the tailgate 400, the lower section 620 of the cradle 600 mates with the tailgate 400 and contributes to securing the tailgate pad 350 to the tailgate 400, and the upper section 620 of the cradle 600 mates with the bicycle and provides an adequate standoff space to protect the bicycle from the tailgate 400 and secure the bicycle.

The cradle 600 may also include a strap 610 to secure the bicycle the cradle 600 and the tailgate protection system 10. In another embodiment the cradle 600 omits the strap 610. The upper section 620 of the cradle 600 generally forms a semi-circular, open tubular shape to mate with a portion of the bicycle frame. In another embodiment, the upper portion 620 of the cradle 600 is formed flat of a compressible, elastic material to secure the bicycle frame to the cradle 600.

The lower section 640 of the cradle 600 is generally configured to mate with the inside, upper edge of the tailgate 400. In one embodiment, the lower section 640 of the cradle 600 is formed in the shape of an angular cutout. In another embodiment, the lower section 640 of the cradle 600 is formed in a right angle. In another embodiment, the lower section 640 of the cradle 600 is formed to match the shape of the inside, upper edge of the truck's tailgate 400. In another embodiment, the lower section 640 of the cradle 600 is generally configured to mate with the outside, upper edge of the tailgate 400, and the upper section 620 is formed to mate with a portion of the bicycle frame.

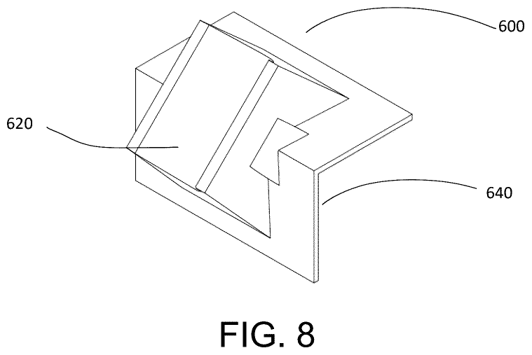

In one embodiment, as shown in FIG. 8, the lower section 640 of the cradle 600 is positioned perpendicularly to the upper section 620 of the cradle 600. In one embodiment, the lower section 640 of the cradle 600 is positioned asymmetrically to the upper section 620 of the cradle 600 so that the bicycle frame rests at an acute angle relative to the tailgate.

In one embodiment the cradle 600 may be made of plastic. In one embodiment the cradle 600 may be made of foam or EVA foam. In another embodiment, the cradle is formed from a material with a durometer of approximately a 50 Shore A. The cradle 600 may be made of a material with a durometer of 40 Shore A to 60 Shore A. The cradle 600 may be made from one or more separate pieces. In one embodiment the upper section 620 of the cradle 600 is secured to the lower section 640 of the cradle. In another embodiment, the upper section 620 of the cradle 600 is formed from a different material than the lower section 640 of the cradle. The upper section 620 may be made from a material with a durometer of 40 Shore A-60 Shore A and the lower section 640 may be made from a harder material with a durometer of 0 Shore D-60 Shore D. In an embodiment, the upper section 620 may be made from a material with a durometer of 0 Shore D 60 Shore D the lower section 640 may be made from a softer material with a durometer of 40 Shore A to 60 Shore A.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

What is claimed is:

1. A tailgate protector system comprising:
a tailgate pad having a bed side and an exterior side;
a cradle coupled to an upper portion of the tailgate pad having an upper section configured to mate to a portion of a frame of a bicycle and lower section configured to mate with a upper edge of the tailgate;
wherein when the tailgate pad is over the tailgate the cradle provides an adequate standoff space to protect the bicycle from the tailgate and assists in securing the tailgate pad to the tailgate to reduce movement of the tailgate pad and the bicycle.

2. The tailgate protector system of claim 1 wherein the lower section of the cradle is configured to mate with an inside corner of the upper edge of the tailgate.

3. The tailgate protector system of claim 1 wherein the cradle further comprises a strap on the upper section to secure the frame.

4. The tailgate protector system of claim 1 wherein the lower section of the cradle is asymmetrical to the upper section of the cradle so that the frame rests at an angle to the tailgate.

5. The tailgate protector system of claim 1 wherein the cradle is formed from a semi-rigid material.

6. The tailgate protector system of claim 1 wherein the lower section of the cradle is an angular cutout formed to match an inside corner of the upper edge of the tailgate.

7. A truck tailgate protector system comprising:
a tailgate pad having a truck bed side and an exterior side;
a strap attached to the truck bed side of the tailgate pad having an anchor configured to pass through a gap between a truck tailgate and a truck bed when the tailgate is down and secure the strap between the truck tailgate and truck bed when the tailgate is up; and
a cradle coupled to an upper portion of the truck bed side of the tailgate pad having an upper section configured to mate to a portion of a bicycle and a lower section configured to mate with an upper edge of the tailgate;
wherein when the tailgate pad is over the tailgate the cradle provides an adequate standoff space to protect the bicycle from the inside corner of the tailgate and assists in securing the tailgate pad to the tailgate to reduce movement of the tailgate pad and the bicycle.

8. The tailgate protector system of claim 7 wherein the lower section of the cradle is configured to mate with an inside corner of the upper edge of the tailgate.

9. The tailgate protector system of claim 7 wherein the cradle further comprises a strap on the upper section to secure the bicycle.

10. The tailgate protector system of claim 7 wherein the lower section of the cradle is asymmetrical to the upper section of the cradle so that the bicycle rests at an angle to the tailgate.

11. The tailgate protector system of claim 7 wherein the anchor is configured to be inserted into a gap between a truck tailgate and a truck bed when the tailgate is down and secure the strap between the truck tailgate and truck bed when the tailgate is up.

12. The tailgate protector system of claim 7 wherein the cradle is formed from a rigid material.
